(19) United States
(12) Patent Application Publication
(10) Pub. No.: US 2022/0403219 A1
(43) Pub. Date: Dec. 22, 2022

(54) MOISTURE-CURABLE POLYURETHANE HOTMELT ADHESIVE HAVING HIGH INITIAL STRENGTH

(71) Applicant: BASF SE, Ludwigshafen am Rhein (DE)

(72) Inventors: Sirus Zarbakhsh, Ludwigshafen am Rhein (DE); Stefan Bokern, Lemforede (DE); Martin Linnebrink, Lemforede (DE); Xuyuan Peng-Poehler, Ludwigshafen am Rhein (DE)

(21) Appl. No.: 17/776,454

(22) PCT Filed: Nov. 13, 2020
(86) PCT No.: PCT/EP2020/082002

§ 371 Date: May 12, 2022

(30) Foreign Application Priority Data
Nov. 15, 2019 (CN) PCT/CN2019/118894
Jun. 26, 2020 (EP) 20165961.2

(51) Int. Cl. C09J 175/08; C09J 5/06; C08G 18/76; C08G 18/12; C08G 18/42; C08G 18/48; C08G 18/62; C08G 18/40; C08G 18/30

(52) U.S. Cl. CPC C09J 175/08; C09J 5/06; C08G 18/7671; C08G 18/12; C08G 18/4238; C08G 18/4825; C08G 18/428; C08G 18/6225; C08G 18/4018; C08G 18/4063; C08G 18/307; C09J 2475/00; C08G 2170/20

(57) ABSTRACT

Described herein is a moisture-curing polyurethane hot-melt adhesive including at least 80% by weight, based on a total weight of the moisture-curing polyurethane hot-melt adhesive, of isocyanate-terminated prepolymer obtainable by mixing diisocyanate (a) with compounds having at least two isocyanate-reactive groups (b) and reacting the mixture to form the isocyanate-terminated prepolymer, where the compounds having at least two isocyanate-reactive groups (b) include at least one polylactide (b1) obtainable by reacting lactide with a linear difunctional starter molecule having 2 to 20 carbon atoms and the isocyanate content of the isocyanate-terminated prepolymer is 1 to 5% by weight. Also described herein is a process for producing such a moisture-curing polyurethane hot-melt adhesive and a method of using the moisture-curing polyurethane hot-melt adhesive in bonding of substrates.

The present invention relates to a moisture-curing polyurethane hot-melt adhesive comprising at least 80% by weight, based on the total weight of the moisture-curing polyurethane hot-melt adhesive, of isocyanate-terminated prepolymer obtainable by mixing diisocyanate (a) with compounds having at least two isocyanate-reactive groups (b) and reacting the mixture to form the isocyanate-terminated prepolymer, wherein the compounds having at least two isocyanate-reactive groups (b) comprise at least one polylactide (b1) obtainable by reacting lactide with a linear difunctional starter molecule having 2 to 20 carbon atoms and the isocyanate content of the isocyanate-terminated prepolymer is 1 to 5% by weight, wherein the starter molecule is selected from the group consisting of diethylene glycol, propanediol, neopentyl glycol, dipropylene glycol, butanediol, pentanediol, hexanediol, heptanediol, octanediol, nonanediol, decanediol, dodecanediol, and mixtures of two or more of these compounds. The present invention further relates to a process for producing such a moisture-curing polyurethane hot-melt adhesive and to the use thereof in bonding of substrates.

Moisture-curing polyurethane hot-melt adhesives are known and are widely used. These usually comprise polyester-based isocyanate-terminated prepolymers obtained by reaction of an excess of diisocyanates, usually based on isomers of diphenylmethane diisocyanate, with polyesterols. Their key advantages are the combination of high initial strength and the ability to react with water and hence to effectively cure and generate high effective bonding once curing is complete.

Classical examples of polyesters used in the production of polyester-based isocyanate-terminated prepolymers for moisture-curing polyurethane hot-melt adhesives are amorphous polyester polyols having a glass transition temperature T_{g} of typically greater than 20° C., which are obtained by esterification of aliphatic, optionally also aromatic diols and diacids, and crystalline polyesterols solid at 20° C., which may be obtained for example by esterification of hexanediol and adipic acid. Such polyesterols are commercially available. An example of such an amorphous polyester polyol is marketed under the trade name Dynacoll® 7130 by Evonik and an example of a crystalline polyesterol is likewise marketed by Evonik under the trade name Dynacoll® 7360.

In addition to these polyesters having a glass transition temperature or melting point of greater than 20° C., other liquid polyesterols or polyetherols may also be used in the production of isocyanate-terminated prepolymers. The moisture-curing polyurethane hot-melt adhesive may, in addition to the isocyanate-terminated prepolymer, for optimization of process properties, open time, and initial strength, may also comprise thermoplastic materials such as thermoplastic polyurethane, polyacrylates or other, preferably aliphatic resins.

Efforts are currently underway to increase the proportion of renewable raw materials in moisture-curing polyurethane hot-melt adhesives.

For that purpose, US 20170002241 discloses the use of glycerol- and fatty acid glyceride-containing polylactides in the production of polyester-based isocyanate-terminated prepolymers. A disadvantage of the isocyanate-terminated prepolymers described in US 2017/0002241 is the low initial strength.

It was an object of the present invention to provide a moisture-curing polyurethane adhesive having a high initial strength, with the isocyanate-terminated prepolymer comprising a high proportion of renewable raw materials.

The object of the invention was achieved by a moisture-curing polyurethane hot-melt adhesive comprising at least 80% by weight, based on the total weight of the moisture-curing polyurethane hot-melt adhesive, of isocyanate-terminated prepolymer obtainable by mixing diisocyanate (a) with compounds having at least two isocyanate-reactive groups (b) and reacting the mixture to form the isocyanate-terminated prepolymer, wherein the compounds having at least two isocyanate-reactive groups (b) comprise at least one polylactide (b1) obtainable by reacting lactide with a linear difunctional starter molecule having 2 to 20 carbon atoms and the isocyanate content of the isocyanate-terminated prepolymer is 1 to 5% by weight, wherein the starter molecule is selected from the group consisting of diethylene glycol, propanediol, neopentyl glycol, dipropylene glycol, butanediol, pentanediol, hexanediol, heptanediol, octanediol, nonanediol, decanediol, dodecanediol, and mixtures of two or more of these compounds. The present invention further relates to a process for producing such a moisture-curing polyurethane hot-melt adhesive and to the use thereof in bonding of substrates.

In the context of the invention, a moisture-curing polyurethane hot-melt adhesive is understood as meaning a mixture comprising a isocyanate-containing prepolymer or the isocyanate-containing prepolymer itself, wherein the mixture includes at least 80% by weight, preferably at least 90% by weight and in particular at least 95% by weight of an isocyanate-containing prepolymer. In addition, a moisture-curing polyurethane adhesive according to the invention may comprise further additives such as surface-active substances, for example mold-release agents and/or defoamers, inhibitors such as diglycol bis(chloroformate) or orthophosphoric acid, plasticizers, inorganic and/or organic fillers such as sand, kaolin, chalk, barium sulfate, silica, and carbon black, oxidation stabilizers, melt auxiliaries such as thermoplastic polymers, dyes and pigments, stabilizers, for example against hydrolysis, light, heat or discoloration, emulsifiers, flame retardants, aging stabilizers, and adhesion promoters, and also catalysts typically used in polyurethane chemistry such as 2,2-dimorpholinodiethyl ether.

In the context of the invention, the isocyanate-terminated prepolymer is the reaction product of diisocyanates (a) with compounds that have at least two isocyanate-reactive groups and optionally with compounds having one isocyanate-reactive group, with the diisocyanate being used in excess.

All aliphatic, cycloaliphatic, and aromatic difunctional isocyanates known from the prior art and any mixtures thereof may be used as the diisocyanates for the production of the isocyanate-containing prepolymer. In addition to diisocyanates, it is also possible to use higher-functionality isocyanates here. If higher-functionality isocyanates are used, the proportion thereof, based on the total weight of the isocyanates used, is preferably less than 40% by weight, more preferably less than 20% by weight, particularly preferably less than 10% by weight, and in particular less than 1% by weight. Further preferably, no higher-functionality isocyanate is used.

Aromatic di- or polyfunctional isocyanates are preferably used. Examples are diphenylmethane 4,4′-, 2,4′-, and 2,2′-diisocyanate (MDI), mixtures of monomeric diphenylmethane diisocyanates and multiring homologs of diphenylmethane diisocyanate (polymer MDI), tetramethylene diisocyanate, hexamethylene diisocyanate (HDI), isophorone diisocyanate (IPDI), naphthalene 1,5-diisocyanate (NDI), toluene 2,4,6-triisocyanate and toluene 2,4- and 2,6-diisocyanate (TDI), or mixtures thereof.

Particular preference is given to using aromatic isocyanates, preferably selected from the group consisting of toluene 2,4-diisocyanate, toluene 2,6-diisocyanate, diphenylmethane 2,4′-diisocyanate, and diphenylmethane 4,4′-diisocyanate, and also mixtures of these isocyanates. In particular, the diisocyanate used is an aromatic isocyanate selected from the group consisting of diphenylmethane 2,4′-diisocyanate and diphenylmethane 4,4′-diisocyanate and mixtures of these isocyanates. In a most preferred embodiment, the proportion of 4,4′-MDI is greater than 50% by weight, more preferably greater than 80% by weight, and in particular greater than 95% by weight, in each case based on the total weight of the isocyanates used.

Isocyanate-reactive compounds (b) having at least two isocyanate-reactive groups used for the production of the isocyanate-containing prepolymer may be any compounds having at least two isocyanate-reactive groups. Preference is given to using polyesterols, polyetherols or polyether-polyesterols that may be obtained, for example, by alkoxylation of polyesters, in particular polyesterols. The isocyanate-reactive compounds (b) here comprise at least one polylactide (b1) obtainable by reacting lactide with a difunctional linear starter molecule having 2 to 20 carbon atoms, wherein the starter molecule is selected from the group consisting of diethylene glycol, propanediol, neopentyl glycol, dipropylene glycol, butanediol, pentanediol, hexanediol, heptanediol, octanediol, nonanediol, decanediol, dodecanediol, and mixtures of two or more of these compounds. The mean OH functionality of compounds (b) is preferably from 1.8 to 2.2, more preferably from 1.9 to 2.1, and in particular 2. The functionality is understood here as meaning the theoretical functionality based on the starting materials.

Polyetherols are produced from one or more alkylene oxides having 2 to 4 carbon atoms in the alkylene radical by known processes, for example by anionic polymerization with alkali metal hydroxides or alkali metal alkoxides as catalysts and with addition of at least one starter molecule having 2 to 5, preferably 2 to 4, more preferably 2 to 3, in particular 2, reactive hydrogen atoms in bonded form or by cationic polymerization with Lewis acids such as antimony pentachloride or boron trifluoride etherate. Moreover, catalysts used may also be multimetal cyanide compounds, so-called DMC catalysts. Examples of suitable alkylene oxides are tetrahydrofuran, 1,3-propylene oxide, 1,2- and 2,3-butylene oxide and preferably ethylene oxide and 1,2-propylene oxide. The alkylene oxides may be used individually, alternately in succession or as mixtures. Preference is given to using 1,2-propylene oxide, ethylene oxide or mixtures of 1,2-propylene oxide and ethylene oxide.

Suitable starter molecules include water or di- and trihydric alcohols such as ethylene glycol, 1,2- or 1,3-propanediol, diethylene glycol, dipropylene glycol, 1,4-butanediol, glycerol, and trimethylolpropane.

The polyether polyols, particularly preferably polyoxypropylene polyols or polyoxypropylene-polyoxyethylene polyols, are obtainable by alkoxylation of a starter molecule having a functionality of 2.0 to 4.0, particularly preferably 2.0 and 3.0, more preferably 2.0 to 2.2, and in particular 2.0, and have a mean content of ethylene oxide based on the total weight of alkylene oxide of 20 to 70% by weight, preferably 25 to 60% by weight, and in particular 30 to 50% by weight. In a further preferred embodiment, the content of propylene glycol is greater than 70% by weight, more preferably greater than 85% by weight, and in particular greater than 95% by weight, based on the total weight of the alkylene oxides used in the production of the polyetherol. The preferred polyetherols have a number-average molecular weight of 400 to 9000 g/mol, preferably 1000 to 6000, more preferably from 1500 to 5000, and in particular from 2000 to 4000 g/mol. Increasing the content of ethylene oxide and reducing the functionality, with the molecular weight unchanged, typically results in a reduction in the viscosity of the polyetherols.

The isocyanate-reactive compounds (b) used may additionally be hydrophobic polyols that have at least one hydrophobic hydrocarbon molecular moiety having at least 8 carbon atoms. The hydrophobic polyol employed in this case is preferably a hydroxyl-functionalized oleochemical compound, an oleochemical polyol. A number of hydroxyl-functional oleochemical compounds are known that may be used. Examples are castor oil, oils such as grapeseed oil, black seed oil, pumpkin seed oil, borage seed oil, soybean oil, wheatgerm oil, rapeseed oil, sunflower oil, peanut oil, apricot kernel oil, pistachio oil, almond oil, olive oil, macadamia oil, avocado oil, sea buckthorn oil, sesame oil, hazelnut oil, evening primrose oil, wild rose oil, hemp oil, safflower oil, walnut oil that have been modified with hydroxyl groups, and fatty acid esters modified with hydroxyl groups and based on myristoleic acid, palmitoleic acid, oleic acid, vaccenic acid, petroselinic acid, gadoleic acid, erucic acid, nervonic acid, linoleic acid, linolenic acid, stearidonic acid, arachidonic acid, timnodonic acid, clupanodonic acid, and cervonic acid. Preference here is given to using castor oil and the reaction products thereof with alkylene oxides or ketone-formaldehyde resins. The latter compounds are marketed by, for example, Bayer AG under the name Desmophen® 1150. In a particularly preferred embodiment, the isocyanate-reactive compounds having at least two isocyanate-reactive groups (b) comprise hydrophobic polyetherols or polyesterols.

Compounds (b) may optionally also comprise chain extenders and/or crosslinkers. The addition of the chain extenders and/or crosslinkers may take place before, together with, or after the addition of the polyols. The chain extenders and/or crosslinkers used are substances having a molecular weight of preferably less than 400 g/mol, particularly preferably of 60 to 350 g/mol, wherein chain extenders have 2 isocyanate-reactive hydrogen atoms and crosslinkers have 3 isocyanate-reactive hydrogen atoms. These may be used individually or in the form of mixtures. Where chain extenders are used, 1,3- and 1,2-propanediol, dipropylene glycol, tripropylene glycol, and 1,3-butanediol are particularly preferred.

If chain extenders, crosslinkers or mixtures thereof are used, these are expediently used in amounts of 1 to 30% by weight, preferably 1.5 to 20% by weight, and in particular 2 to 10% by weight based on the weight of polyisocyanates, relative to polymeric isocyanate-reactive compounds and chain extenders and/or crosslinkers; preferably no chain extenders and/or crosslinkers are used.

The polylactide (b1) is obtainable by reacting lactide with a linear difunctional starter molecule having 2 to 20 carbon atoms. The starter molecule is selected from the group consisting of monoethylene glycol, diethylene glycol, propanediol, neopentyl glycol, dipropylene glycol, butanediol, pentanediol, hexanediol, heptanediol, octanediol, nonanediol, decanediol, dodecanediol, and mixtures of two or more of these compounds. The linear starter molecule preferably comprises 1,6-hexanediol, with particular preference given to the exclusive use of 1,6-hexanediol as the linear starter molecule.

The reaction of the linear starter molecule with the lactide is typically carried out in neat form, preferably using a metal catalyst, for example a tin catalyst or so-called double-metal cyanide catalysts (also referred to as “DMC catalysts”). DMC catalysts are known and already commonly described in the prior art.

The lactide may be used in any form here, for example L-lactide, D-lactide, meso-lactide or any mixture thereof. Preference is given to using L-lactide, D-lactide or meso-lactide, in each case in purities preferably greater than 90% by weight. In addition to lactides, it is also possible to use other alkylene oxides such as ethylene oxide, 1,3- or preferably 1,2-propylene oxide or 1,2- or 2,3-butylene oxide and particularly preferably 1,2-propylene oxide. If alkylene oxides are used in addition to the lactide, this is preferably done in block structure. Particularly preferably, the alkylene oxides are used as the end block, which means that the starter molecule is reacted with the lactide in a first step, after which the resulting polymer undergoes chain extension with the alkylene oxide in a second step. The proportion of lactide groups based on the total weight of the groups in the polylactide (b1) added onto the starter molecule is from 50 to less than 100%, preferably from 70 to 99.5% by weight. Particularly preferably, the proportion of lactide groups based on the total weight of the groups in the polylactide (b1) added onto the starter molecule is 100% by weight. The hydroxyl value of the polylactide (b1) is preferably 35 to 230 mg KOH/g.

In a particularly preferred embodiment of the present invention, the compounds having at least two isocyanate-reactive groups (b) comprise, in addition to the polylactide (b1), further polyols (b2) that are different from the polylactide (b1). These include the above-described polyetherols, polyesterols, hydrophobic polyols, and polyetherol-polyesterols, wherein the number-average molecular weights of the polyols (b2) are at least 500 g/mol. The compounds (b2) preferably have a functionality of 2 to 4, more preferably 2 to 3, and in particular 2. In a most preferred embodiment of the present invention, the polyols (b2) comprise a mixture of one or more polyether polyols (b2a) and one or more polyester polyols (b2b). The polyether polyols (b2a) and polyesterols (b2b) preferably have a number-average molecular weight of 1500 to 6000 g/mol, more preferably 2000 to 4000 g/mol. In particular, the polyester (b2b) is a polyester that was obtained starting from hexanediol, in particular 1,6-hexanediol, as diol component. The polyether (b2a) used is preferably a polyether that includes at least 50% by weight, preferably at least 70% by weight, particularly preferably at least 85% by weight, more preferably at least 95% by weight, and is in particular exclusively propylene oxide, based on the alkylene oxides used in the production of the polyether (b2a). In a particularly preferred embodiment, component (b2) comprises no further compounds having at least two isocyanate-reactive groups in addition to the polyethers (b2a) and the polyesters (b2b).

The proportion of polylactide (b1) based on the total weight of compounds having at least two isocyanate-reactive groups (b) is preferably 5 to 90% by weight, particularly preferably 10 to 80% by weight, more preferably 15 to 50% by weight, and in particular 20 to 40% by weight. The proportion of component (b2) is preferably 10 to 95% by weight, particularly preferably 20 to 90% by weight, more preferably 50 to 85% by weight, and in particular 60 to 80% by weight, wherein the ratio of polyether (b2a) to polyester (b2b) is preferably 4:1 to 1:2, more preferably 3:1 to 1:1. Particularly preferably, component (b) in addition to the polyols (b1) and (b2) comprises less than 10% by weight of compounds having at least two isocyanate-reactive hydrogen atoms, more preferably less than 5% by weight, and in particular none.

It is also possible to use compounds having only one isocyanate-reactive group in the production of the prepolymers according to the invention. These are preferably polyether monools that are obtained starting from monofunctional starter molecules, for example ethylene glycol monomethyl ether, in analogous manner to the polyetherols described above. The molecular weight of the polyether monools used here is preferably 100 to 1000 g/mol. If polyether monools are used, the weight ratio of polyether monool to compounds (b) is preferably from 1:30 to 4:1; more preferably no compounds having only one isocyanate-reactive group are used.

Customary polyurethane catalysts, preferably amine-containing polyurethane catalysts, may optionally likewise be used in the production of the isocyanate-containing prepolymer. Such catalysts are described, for example, in “Kunststoffhandbuch [Plastics Handbook], volume 7, Polyurethane [Polyurethanes]”, Carl Hanser Verlag, 3rd edition 1993, chapter 3.4.1. The catalysts preferably comprise strongly basic amine catalysts. Examples of these include amidines such as 2,3-dimethyl-3,4,5,6-tetrahydropyrimidine, tertiary amines such as triethylamine, tributylamine, dimethylbenzylamine, N-methyl-, N-ethyl-, and N-cyclohexylmorpholine, N,N,N′,N′-tetramethylethylenediamine, N,N,N′,N′-tetramethylbutanediamine, N,N,N′,N′-tetramethylhexanediamine, pentamethyldiethylenetriamine, tetramethyldiaminoethyl ether, bis(dimethylaminopropyl)urea, dimethylpiperazine, 1,2-dimethylimidazole, 1-azabicyclo[3.3.0]octane, and preferably 1,4-diazabicyclo[2.2.2]octane, and alkanolamine compounds such as triethanolamine, triisopropanolamine, N-methyl- and N-ethyldiethanolamine, and dimethylethanolamine. The catalysts may be used individually or as mixtures. Preferably, no catalysts are used in the production of the isocyanate-containing prepolymer.

In the production of the isocyanate-containing prepolymer, an excess of the described polyisocyanates is reacted with the compounds having at least two isocyanate-reactive groups, optionally compounds having one isocyanate-reactive group, to form the prepolymer, for example at temperatures of 30 to 100° C., preferably at about 80° C. In this process, polyisocyanate is mixed together with compounds having at least two isocyanate-reactive groups, optionally compounds having one isocyanate-reactive group, preferably in a ratio of isocyanate groups to isocyanate-reactive groups of 1.5:1 to 15:1, preferably 1.8:1 to 8:1. The mixing ratio of polyisocyanates, polymeric compounds having at least two isocyanate-reactive groups, optionally compounds having one isocyanate-reactive group, and optionally chain extenders and/or crosslinkers is chosen such that the isocyanate content (NCO content) of the prepolymer produced is in the range from 1 to 5%, preferably 1.2 to 3%, more preferably 1.5 to 2.5%, and in particular 1.6 to 2.0% by weight based on the total weight of the isocyanate prepolymer produced. Volatile isocyanates may then if necessary be removed, preferably by thin-film distillation. The viscosity of the isocyanate prepolymers according to the invention is preferably from 5 to 1000 Pas, more preferably from 10 to 300 Pas, and in particular from 15 to 200 Pas, in each case at 40° C. This can be adjusted, for example, through adjustment of the isocyanate index, the mean functionality, and the polyols and isocyanates used. Such modifications are known to those skilled in the art. The mean isocyanate functionality of the isocyanate prepolymers is preferably 2.0 to 2.9, more preferably 2.0 to 2.2.

The use of melt auxiliaries such as thermoplastic polymers in the production of moisture-curing polyurethane hot-melt adhesives is well known. In a preferred embodiment, the polyurethane hot-melt adhesive according to the invention comprises thermoplastic polymer that has no isocyanate-reactive groups. All thermoplastics may be used here. The thermoplastics preferably have a melting point of 70 to 250° C., particularly preferably 80 to 220° C., more preferably 90 to 180° C., and in particular 100 to 160° C. Examples of such thermoplastic plastics are thermoplastic polyurethane, polyacrylates or polyesters, with particular preference given to the use of thermoplastic polyurethanes and/or polyacrylates as thermoplastics.

The polyurethane hot-melt adhesive according to the invention may be used for bonding substrates, for example by applying the moisture-curing polyurethane hot-melt adhesive to at least one substrate at temperatures of greater than 80° C., preferably 90 to 200° C., more preferably 100 to 150° C., applying a second substrate to the moisture-curing polyurethane hot-melt adhesive, and allowing the moisture-curing polyurethane hot-adhesive to cure, preferably at temperatures of lower than 100° C. On cooling to temperatures of lower than 110° C., the polyurethane hot-melt adhesive according to the invention shows very good adhesion and a rapid increase in viscosity, which results in very good initial strength in the adhesive bond. Polyurethane hot-melt adhesives according to the invention also show good adhesion and strength in the cured adhesive bond, and very good hydrolysis resistance, and have a high content of biobased raw materials. Substrates may be materials such as wood, glass, metals, textiles, plastics, and natural materials such as fibers. The bonding of textiles to fiber-reinforced polyurethane plastics is particularly preferred.

The invention is elucidated hereinbelow with reference to examples.

Moisture-curing polyurethane adhesives according to the present invention (inventive examples) and comparative examples were produced and the increase in viscosity on curing thereof was investigated. The following starting materials were used for this:

Polyesterol 1: polyesterol formed from hexanediol and adipic acid having a functionality of 2, a hydroxyl value of 30 mg KOH/g, and a melting point of 55° C., obtainable under the trade name Dynacoll© 7360 from Evonik

Polyetherol 1: polypropylene glycol having a functionality of 2 and a hydroxyl value of 56 mg KOH/g

Polyetherol 2: polypropylene glycol having a functionality of 2 and a hydroxyl value of 28 mg KOH/g

The lactide polyols were produced by reaction of an OH-containing starter with Puralact L ((3S-cis)-3,6-dimethyl-1,4-dioxane-2,5-dione, CAS number 4511-42-6)

Lactide polyol 1 polylactide having 1,6-hexanediol as starter molecule, a functionality of 2, and a hydroxyl value of 56 mg KOH/g, produced using 100 ppm of tin bis(2-ethylhexanoate) at 175° C. (catalyst amount based on overall mixture).

Lactide polyol 2 polylactide having 1,6-hexanediol as starter molecule, a functionality of 2, and a hydroxyl value of 56 mg KOH/g, produced using double-metal cyanide catalyst (1000 ppm based on overall mixture) at 200° C. (catalyst amount based on overall mixture).

Lactide polyol 3 polylactide having neopentyl glycol as starter molecule, a functionality of 2, and a hydroxyl value of 56 mg KOH/g, produced using 100 ppm of tin bis(2-ethylhexanoate) at 175° C. (catalyst amount based on overall mixture).

Lactide polyol 4 polylactide having neopentyl glycol as starter molecule, a functionality of 2, and a hydroxyl value of 37 mg KOH/g, produced using 100 ppm of tin catalyst at 175° C.

Acrylate polymer: thermoplastic acrylate polymer having a number-average molecular weight of 34 000 g/mol, obtainable under the trade name Elvacite© 2013 from Lucite International.

Isocyanate: MDI mixture comprising approx. 99% by weight of 4,4′-MDI and approx. 1% by weight of 2,4′-MDI

The moisture-curing polyurethane adhesives were produced by reacting the starting materials in the weight ratio shown in table 1 (values are in parts by weight unless otherwise stated).

TABLE 1

| | Comparison | Example 1 | Example 2 | Example 3 | Example 4 |
|---|---|---|---|---|---|
| Polyesterol 1 | 35.0 | 13.0 | 13.0 | 13.0 | 13.0 |
| Polyetherol 1 | 14.0 | 14.0 | 14.0 | 14.0 | 14.0 |
| Polyetherol 2 | 18.0 | 18.0 | 18.0 | 18.0 | 18.0 |
| Acrylate polymer | 22.0 | 22.0 | 22.0 | 22.0 | 22.0 |
| Lactide polyol 1 | | 15 | | | |
| Lactide polyol 2 | | | 15 | | |
| Lactide polyol 3 | | | | 15 | |
| Lactide polyol 4 | | | | | 15 |
| Isocyanate | 11.0 | 11.0 | 11.0 | 11.0 | 10.2 |
| Isocyanate | 1.89 | 1.89 | 1.89 | 1.89 | 1.89 |
| content | | | | | |

The viscosities of the moisture-curing polyurethane adhesives obtained were determined at different temperatures in accordance with ASTM D 3236 in a Brookfield viscometer with single-measurement geometry SC27 spindle. These values are shown in table 2.

TABLE 2

| | Comparison | | Example 1 | | Example 2 | | Example 3 | | Example 4 | |
|---|---|---|---|---|---|---|---|---|---|---|
| η at 150° C. | 3.2 | Pa · s | 3.4 | Pa · s | 4.0 | Pa · s | 3.4 | Pa · s | 4.0 | Pa · s |
| η at 130° C. | 7.5 | Pa · s | 7.4 | Pa · s | 9.0 | Pa · s | 10.1 | Pa · s | 17.5 | Pa · s |
| η at 120° C. | 12.6 | Pa · s | 11.8 | Pa · s | 15.4 | Pa · s | 12.6 | Pa · s | 70.7 | Pa · s |
| η at 110° C. | 14.8 | Pa · s | 21.8 | Pa · s | 43.2 | Pa · s | 44.8 | Pa · s | 183 | Pa · s |
| η at 100° C. | | | | | 251 | Pa · s | 206 | Pa · s | 1560 | Pa · s |
| η at 90° C. | 65.8 | Pa · s | 178 | Pa · s | 1042 | Pa · s | 2258 | Pa · s | | |
| η at 80° C. | | | 966 | Pa · s | | | | | | |
| η at 70° C. | 200 | Pa · s | | | | | | | | |

The viscosity values obtained for the inventive examples show that application at temperatures of greater than 100° C. is possible without difficulty on account of the low viscosity, but, on cooling to temperatures of lower than 100° C., there is a rapid increase in viscosity that results in the adhesive joint attaining high initial strength before curing of the adhesive is complete. The comparative examples likewise demonstrate an increase in viscosity, but this is smaller with decreasing temperature than that of the inventive examples.

1. A moisture-curing polyurethane hot-melt adhesive comprising at least 80% by weight, based on a total weight of the moisture-curing polyurethane hot-melt adhesive, of isocyanate-terminated prepolymer obtainable by mixing diisocyanate (a) with compounds having at least two isocyanate-reactive groups (b) and reacting the mixture to form the isocyanate-terminated prepolymer,
wherein the compounds having at least two isocyanate-reactive groups (b) comprise at least one polylactide (b1) obtainable by reacting lactide with a linear difunctional starter molecule having 2 to 20 carbon atoms and an isocyanate content of the isocyanate-terminated prepolymer is 1 to 5% by weight, wherein the starter molecule is selected from the group consisting of diethylene glycol, propanediol, neopentyl glycol, dipropylene glycol, butanediol, pentanediol, hexanediol, heptanediol, octanediol, nonanediol, decanediol, dodecanediol, and mixtures of two or more of these compounds.

2. The moisture-curing polyurethane hot-melt adhesive according to claim 1, wherein the starter molecule is 1,6-hexanediol.

3. The moisture-curing polyurethane hot-melt adhesive according to claim 1, wherein the polylactide (b1) is a copolymer and a proportion of lactide groups based on a total weight of the groups in the polylactide (b1) added to the starter molecule is 50 to less than 100% by weight.

4. The moisture-curing polyurethane hot-melt adhesive according to claim 3, wherein the polylactide (b1) is obtainable by reacting the starter molecule in a first step with lactide and in a second step with alkylene oxide.

5. The moisture-curing polyurethane hot-melt adhesive according to claim 1, wherein the polylactide (b1) is a copolymer and wherein a proportion of lactide groups based on a total weight of the groups in the polylactide (b1) added to the starter molecule is 100% by weight.

6. The moisture-curing polyurethane hot-melt adhesive according to claim 1, wherein a hydroxyl value of the polylactide (b1) is 35 to 230 mg KOH/g.

7. The moisture-curing polyurethane hot-melt adhesive according to claim 1, wherein a DMC catalyst is used in the production of the polylactide (b1).

8. The moisture-curing polyurethane hot-melt adhesive according to claim 1, wherein the diisocyanate (a) is selected from the group consisting of 2,4-MDI, 4,4′-MDI, and mixtures thereof.

9. The moisture-curing polyurethane hot-melt adhesive according to claim 1, wherein the compounds having at least two isocyanate-reactive groups (b) further comprise polyols (b2) that are different from the polylactide (b1).

10. The moisture-curing polyurethane hot-melt adhesive according to claim 9, wherein a proportion of polylactide (b1) based on a total weight of compounds having at least two isocyanate-reactive groups (b) is 5 to 90% by weight.

11. The moisture-curing polyurethane hot-melt adhesive according to claim 1, wherein, in addition to the isocyanate-terminated prepolymer, further comprises thermoplastic polymer that has no isocyanate-reactive groups.

12. The moisture-curing polyurethane hot-melt adhesive according to claim 1, wherein the moisture-curing polyurethane hot-melt adhesive further comprises auxiliaries and additives.

13. A process for producing a moisture-curing polyurethane hot-melt adhesive comprising at least 80% by weight, based on a total weight of the moisture-curing polyurethane hot-melt adhesive, of isocyanate-terminated prepolymer, wherein diisocyanate (a) is mixed with compounds having at least two isocyanate-reactive groups (b) and the mixture is reacted to give the isocyanate-terminated prepolymer, wherein the compounds having at least two isocyanate-reactive groups (b) comprise at least one polylactide (b1) obtainable by reacting lactide with a linear difunctional starter molecule having 2 to 20 carbon atoms and wherein quantitative proportions of the diisocyanate (a) and the compounds having at least two isocyanate-reactive groups (b) are adjusted so that the resulting isocyanate-terminated prepolymer has an isocyanate content of 1 to 5% by weight and optionally mixing the isocyanate-terminated prepolymer obtained with a thermoplastic polymer and/or auxiliaries and additives, wherein the starter molecule is selected from the group consisting of diethylene glycol, propanediol, neopentyl glycol, dipropylene glycol, butanediol, pentanediol, hexanediol, heptanediol, octanediol, nonanediol, decanediol, dodecanediol, and mixtures of two or more of these compounds.

14. A method of using the moisture-curing polyurethane hot-melt adhesive according to claim 1 for bonding substrates by applying the moisture-curing polyurethane hot-melt adhesive to a substrate at temperatures of greater than 80° C., applying a second substrate to the moisture-curing polyurethane hot-melt adhesive, and allowing the moisture-curing polyurethane hot-melt adhesive to cure.

15. (canceled)
